(19) United States
(12) Patent Application Publication
(10) Pub. No.: US 2005/0143495 A1
(43) Pub. Date: Jun. 30, 2005

(54) Organomineral pigment fillers, methods for their manufacture and applications

(76) Inventors: Valentina Padareva, Ontario (CA); Gerard Mooney, Ontario (CA); Georgi Kirov, Sofia (BG); Dimitar Kirov, Sofia (BG)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/498,649

(22) PCT Filed: Dec. 16, 2002
(86) PCT No.: PCT/CA02/01933

(30) Foreign Application Priority Data
Dec. 14, 2001 (US) 60339441

(51) Int. Cl. C08K 3/34; C08K 9/00

(52) U.S. Cl. 523/216; 524/450

(57) ABSTRACT

This invention related to organomineral pigment-fillers, obtained as a result of specific reactions between inorganic ionic material and organic substances with ionic chromogens. The materials obtained as a result of these reactions are used as pigments added to various composites with organic or inorganic matrix—thermoset and thermoplastic polymers, paints and coatings, plaster and concrete parts paper and other useful materials. When used as fillers, the organomineral pigment-fillers have all the advantages of the appropriate inorganic matrix combined with controlled surface effects at the borderline fillerchromogen matrix.

### TECHNICAL FIELD

It can be appreciated that pigments, fillers and colorants have been in use for years. The use of inorganic fillers in composite materials, which has increased significantly over the last 10-15 years, mainly as a method to reduce the consumption of raw materials. The addition of inorganic fillers to various composite materials modifies their properties, which allows for the creation of totally new materials. Typically the mineral fillers are added to the composite along with pigments which give to the obtained composite the color required for the processed parts. Consequently, the combined application of inorganic fillers as pigments at the same time is of substantial interest to the industry.

### BACKGROUND ART

The presently known organomineral colorants and methods for their production are associated primarily with the coloring of the composite materials (mainly thermoplastic polymers), substituting for the expensive organic pigments as taught in U.S. Pat. No. 3,950,180. High levels of saturation of the pigment with organic chromogens are taught on the order of 40-50 wt. % on the mineral substrate, and due to intercalation between the inter-layers.

Also taught in the prior is the intercalation of clay materials or other minerals with layered structure as shown in W01/04216 A1. The excessive increase of the dye quantity, which can be achieved when the chromogens are intercalated between the interlayers of clay mineral substrates (clays, hydrotalcite), does not improve the color of the composite despite the high optic color intensity of the mineral itself.

U.S. Pat. No. 5,106,420 teaches the incorporation of polymeric counter ionic fixatives, and method for making these pigments are rather expensive and relatively more complex.

A major disadvantage of organic dyes is their relatively low temperature and ultra-violet (UV) radiation stability. Moreover these substances exhibit the tendency to leach out from the colored materials.

Another disadvantage of the conventional colorants is that to produce pigments, with high color intensity at optimum levels of consumption, the high concentration of organic chromogens required can lead to negative consequences, for example, they can migrate and transform in the matrix of the colored composite material.

Economic demands for increased productivity from injection molding of large parts are stimulating the search for improved compounded materials. The use of nucleating agents for polyolefins which accelerate crystallization, or rather increase the recrystallization temperature (cooling cycle) above the natural resin is well known. The recrystallization rates of polyolefins are known to be increased by the presence of these nucleating agents. A vast known variety of nucleating agents exist. Examples of a few of the inorganic nucleating agents are talc, mica, silica, kaolin, clay, attapulgite, romeite powder, quartz powder, zinc oxide, diatomaceous earth, montmorillonite, vermiculite, amorphous silica, glass powder, silica-alumina, wollastonite, carbon black, pyrophyllite, graphite, zinc sulfide, boron nitride, silicon resin powder, and silicates, sulfates, carbonates, phosphates, aluminates and oxides of calcium, magnesium, aluminum, lithium, barium and titanium.

Organic compounds are well known nucleating agents for polyolefins. Examples of known organic nucleating agents conventionally used in the art include for example, aliphatic carboxylic acid metal salts, metal salts of aromatic carboxylic acids such as benzoic acid and terephthalic acid, aromatic phosphonic acids and metal salts thereof, aromatic phosphoric acid metal salts, metal salts of aromatic sulfonic acids and salts such as benzenesulfonic acid, or sodium salt thereof, and naphthalenesulfonic acid, metal salts of b-diketones, polymeric compound having metal salt of carboxyl groups, and fine powders of crystalline polymer such as 4,6 nylon, polyphenylenesulfide ketone, and polyester prepared using parahydroxybenzoic acid as a monomer. Further nucleating agents include sodium salts of methylene-bis-(2,4-di-t-butylphenol)phosphoric acid or b-nucleating agents, such as adipic acid dianilide, dibenzoquinacridone or N,N′-dicyclohexyl-2,6-naphthalene dicarboxamide.

Nucleating agents having been introduced for reducing cycle times of injection moldings especially for increased output in injection molding of large shot sizes, on the order of 1 kg and higher. Further problems in high output molding process occur especially with molds cavities designed for large articles having a surface-to-volume ratio greater than about 3, and especially in a 4-10 ratio of surface area-to-volume. At injection pressures of from 500-1300 kg/cm², and especially at the upper limit of the resin flow capability, the incidence of warping of the ejected molding upon cooling is a recurring problem. Although it is possible to alleviate warping generally by molding polyolefin at lower injection pressure and speed, the reduction in productivity is unacceptable. The problem of warping becomes more evident when coloring pigments are used. Many pigments contribute to warping in injection-molded articles of useful shapes and weight.

The rotation speed of the polyolefin injection screw is typically 10-300 rpm but can be increased when the molding cycle is reduced. However, excessive increase in rotational frequency is unfavorable because it causes increased warpage of the finished parts.

Thermoplastic polyolefins are often colored to match a requested color. A prevalent type of pigment used is Phthalocyanine blues and greens. These are inexpensive to use. However it is known in the art that polyolefin hydroperoxides are decomposed by pigments e.g. copper phthalocyanine blue, -green, ultramarine blues, chromium oxides and iron oxides. Hydroperoxides decompose into radical byproducts which promote accelerated UV degradation of the plastic. See, H. M Gilroy and M. G. Chan, Bell Laboratories, Murray Hill, NJ article entitled Effect of Pigments on the Aging Characteristic of Polyolefins. Also many of these pigments are known to shift the recrystallization temperatures of polyolefins, leading to warping of injection moldings particularly in large shot sizes and moldings having a surface area to volume ratio of greater than or equal to 2. It has been observed that warpage occurs in the use of copper phthalocyanine blue type pigment at the 0.02 wt % level. More typical use levels of copper phthalocyanine blue are at 0.10 wt % and usually used at a level as high as 0.3% to 0.6% wt.

It would be industrially important to provide nonwarping, inexpensive alternative for the coloration of polyolefins which are both environmentally sound and also result in essentially no change in the recrystallization temperatures for polyolefin injection molding compounds, especially for large colored moldings of a shot size 1 kg-50 kgs, yet allowing high production rates resulting in no warpage.

### SUMMARY OF THE INVENTION

A primary object of the present invention is to provide further organomineral pigment fillers (OMPF), and methods for their manufacture and applications that overcome the shortcomings of the prior art. In view of the foregoing disadvantages inherent in the known types of pigments now present in the prior art, the present invention provides new organomineral pigment-fillers, methods for their manufacture and their applications.

In accordance with another aspect of the invention here is provided colorfast, injection molded articles, substantially absent warping, preferably absent a nucleating agent, and comprising a polyolefin compound comprising selected OMPF as specified herein which contains an anionic or cationic crystalline, micronized mineral particles, and ionic bound dye in amount not exceeding the surface ion-exchange capacity of the particles. Non-warping injection molded articles therefrom, especially those of a minimum shot size of 1 kg, and a surface to volume ratio greater than or equal to 2 exhibit substantial improvements shown herein. In general, the final let down amount of OMPF loading level in polyolefins, and polyamide resins can range from 0.5 to 50 wt %, but OMPF loading is very effective at let down levels of from 1 to 5 percent by weight based on the weight of polyolefin injection molding compound. As to the OMPF, a defined range of 0.01 to 15 wt % of ionic bound dye such amount not exceeding the surface ionic exchange capacity of the crystalline, micronized mineral, and preferably 1.0 to 8 wt. % of ionic bound dye is present on weight of OMPF. The dye contains ionic chromogens fixed by ion exchange on the surface of micronized zeolite mineral matrix.

In these respects, the organomineral pigment fillers in conjunction with the polyolefin injection molding compounds, their manufacture and applications according to the present invention substantially depart from the conventional concepts and designs of the prior art. It is therefore an aim of the invention to provide reinforced colored polyolefin compounds adapted for high output injection moldings, and injection molded products therefrom exhibiting nonwarping characteristics and improved the light fastness and color intensity of pigmented polyolefins with improved long term color aging properties.

The present invention generally comprises organomineral pigment-fillers, obtained as a result of specific reactions between inorganic ionic materials and organic substances with ionic chromogens which are used as pigment-fillers to be added to various composites with organic or inorganic matrix—thermoset and thermoplastic polymers, rubbers, paints and coatings, plaster and concrete parts, paper and other useful materials. When used as fillers, the organomineral pigment-fillers have all the advantages of the appropriate inorganic matrix combined with controlled surface effects at the borderline filler-chromogen layer.

An object of the present invention is to provide organomineral pigment fillers, and methods for their manufacture and applications of organomineral pigment-fillers, obtained as a result of specific reactions between inorganic ionic materials and organic substances with ionic chromogens, with the materials obtained as a result of these reactions to be used as pigment fillers added to various composites with organic or inorganic matrix—thermoset and thermoplastic polymers, rubbers, paints and coatings, plaster and concrete parts, paper, and other useful materials.

Another object is to provide organomineral pigment fillers, and methods for their manufacture and applications that create organomineral pigment-fillers which have high color intensity and in which the chromogens and any other ancillary substances are fixed on the surface of mineral particles and which give equal or higher efficacy of the currently existing colorants. At the same time the organomineral pigment fillers according to the invention contribute all the advantages of their inorganic matrix to the colored composite material.

Another object is to provide organomineral pigment fillers, and methods for their manufacture and applications that ensure that the object of the invention is achieved by using a general method for affixing the ionic chromogens on the surface of the mineral particles. This method is based on the interaction of the ionic chromogens with the opposite ions of the mineral matrix which has ion-exchange properties.

Another object is to provide organomineral pigment fillers, and methods for their manufacture and applications that ensure that the chromogens and any other auxiliary substances are dissolved in a polar solvent, and in such a way that they can come into contact with the inorganic ion exchanger. The rate of interaction of the two opposite ionic components is high and the solved chromogen is depleted completely if it is applied in a quantity corresponding to the surface ion-exchange capacity of the mineral matrix.

It is an important aspect of the invention to provide organomineral pigment fillers, and methods for their manufacture and applications that make possible the obtaining of the following phenomena on the boundary mineral filler-chromogen matrix complete inner reflection, opalescence and other complicated cooperative optical effects, depending on the used ionic mineral matrix and respectively on the thickness of the chromogen layer.

The organomineral pigment-fillers described above ensure that the use of other polar substances, sorbed together or after the chromogen exchange on the basis of the previously described mechanism, allow for the modification of the properties of the chromogen layer, while at the same time both the coloring intensity can be increased and other useful properties such as bactericidal action, compatibilizing, plasticizing and anticorrosion action, can be obtained. At the same time the adsorption, surface, ion exchange, catalytic and other properties of the structure of the mineral filler are completely preserved.

Another important aspect of the invention is to provide organomineral pigment fillers, and methods for their manufacture and applications that ensure that the disclosed organomineral pigment-fillers exhibit high coloring efficiency. To achieve the same color intensity lower concentrations of the organic dyes are used.

Further, the organomineral pigment-fillers of the present invention have increased stability under the influence of light, oxygen and heat in comparison with the neat organic dyes. The reason for this is the protective action of the mineral substrates with ionic character which participate and suppress the processes of oxidation. As a result the weathering stability of the materials is significantly improved.

The present organomineral pigment-fillers do not yield any environmental hazard. The organomineral pigment-fillers of this invention are incorporated into the matrix materials using the conventional methods.

Accomplishment of the above objects in accordance with this invention may be embodied in various forms illustrated, and in other forms in view of the disclosure above accompanying drawings, attention being called to the fact, however, that the description and drawings are illustrative only, and that changes may be made in the specific constructions and illustrated embodiments, but it is understood that the invention is not limited in its application to the foregoing illustrated formulations and examples set forth. The invention is capable of other embodiments and of being practiced and carried out in various ways.

### BRIEF DESCRIPTION OF DRAWINGS

FIG. 1 illustrates Comparison of 0.10% neat Dye Basic Red 9 (A) versus same amount of Dye on zeolite (B) in polyamide.

FIG. 2 illustrates Comparison of 0.01% Neat Dye Basic Red 9 Addition (A) vs. the Dye Supported on Zeolites (B) in polyamide.

FIG. 3 illustrates Comparison Red Dye Fluorescence under Black Light (A) vs. Dye supported on Zeolites (B) in polyamide.

FIG. 4 illustrates Comparison of 0.02% neat dye Magenta 8122 (A) versus same amount of dye on zeolite (B) in Polyethylene.

FIG. 5 illustrates Comparisons of 0.02% neat dye Fuchsia 8356 (A) versus same amount of dye on zeolite (B) in Polyethylene.

FIG. 6 illustrates Nylon 6 Colored with Sandolan® Brilliant Red Dye Supported on Hydrotalcite.

FIG. 7 illustrates Nylon 6 Colored with Sandolan® Yellow E-2GL Dye Supported on Hydrotalcite.

FIG. 8 illustrates a comparison of 0, 300 and 400 QUV exposure of HDPE samples colored with 0.02% Apex dye Orange 21 (A) and 0 and 400 QUV exposure of HDPE samples colored with the same amount Dye Apex Orange 21 fixed on zeolite (B).

FIG. 9 is a photograph of a HDPE injection molded plaque colored with copper phthalocyanine blue at 15:1 wt./wt. after 1,100 hours QUV340 Exposure.

FIG. 10 is a photograph of a HDPE injection molded plaque colored with copper phthalocyanine blue at 15:1 wt./wt. after 800 hours QUV exposure.

FIG. 11 is a photograph of an HDPE molded plaque containing 0.10% copper phthalocyanine blue pigment exposed for 1,100 hours QUV340.

FIG. 12 is a photograph of an HDPE injection molded plaque colored with copper phthalocyanine blue at 15:1 after exposure to 1,100 hours QUV340.

FIG. 13 is a photograph of an HDPE injection molded plaque colored with 1 wt. % Zeodex Blue and UV absorber after 1,100 hours of QUV340 Exposure.

FIG. 14 is a photograph of an HDPE injection molded plaque containing 1% Zeodex Blue pigment and a combination of UV absorber and HALS after 1,100 hours QUV340 exposure.

FIG. 15 is a photograph of an HDPE injection molded plaque containing 1% Zeodex Blue pigment and a combination of UV absorber and HALS after 1,100 hours of QUV340 Exposure.

FIG. 16 is a photograph of an HDPE injection molded beverage crate containing 1% Zeodex Red pigment.

FIG. 17 is a photograph of an HDPE injection molded beverage crate containing 1% Zeodex Blue.

FIG. 18 is a photograph of an HDPE molded plaques containing copper phthalocyanine blue T 15:1 after exposure to 1,100 hours QUV340.

### BEST MODE FOR CARRYING OUT THE INVENTION

Turning now descriptively to the drawings, in which similar reference characters denote similar elements throughout the several views, the attached figures illustrate the application of organomineral pigment fillers, obtained as a result of specific reactions between inorganic ionic materials and organic substances with ionic chromogens which are used as pigment fillers to be added to various composites with organic or inorganic matrix—thermoset and thermoplastic polymers, rubbers, paints and coatings, plaster and concrete parts, paper and other useful materials. When used as fillers, the organomineral pigment-fillers have all the advantages of the appropriate inorganic matrix combined with controlled surface effects at the borderline filler-chromogen matrix.

The goal of the invention is achieved by applying a general method for affixing the ionic chromogens on the surface of the mineral particles. This method is based on the interaction of the ionic chromogens with the opposite ions of the mineral matrix which has ion exchange properties. For this purpose the chromogens and any other auxiliary substances are dissolved in a polar solvent and in this way they can come into contact with the inorganic ion exchanger. The rate of interaction of the two opposite ionic components is high and the solved chromogen is depleted completely if it is applied in a quantity corresponding to the surface ion-exchange capacity of the mineral matrix. The quantity of the dye is very important for achieving the coloring effects. The thickness of the chromogen layer depending on the used matrix makes possible the obtaining of the following phenomena on the boundary mineral filler-chromogen layer: complete inner reflection, opalescence and other complicated cooperative optical effects. The excessive increase of the dye quantity, which can be achieved when the chromogens are intercalated between the interlayers of clay mineral substrates (clays, hydrotalcite), does not improve the color of the composite despite the high optic color intensity of the filler itself. In this case, the usage of other polar substances sorbed together or after the chromogen exchange on the basis of the previously described mechanism, allows for the modification of the properties of the chromogen layer, while at the same time both the coloring intensity can be increased and other useful properties such as bactericidal action, compatibilizing, plasticizing and anticorrosion action can be obtained. At the same time the adsorption, surface, ion exchange, catalytic and other properties of the structure of the mineral filler are completely preserved.

Further, the organomineral pigment-fillers have increased stability under the influence of light, oxygen and heat in comparison with the neat organic dyes and pigments. The reason for this is the protective action of the mineral substrates with ionic character which participate and suppress the processes of oxidation. As a result the weathering stability of the colored composite materials is significantly increased. Another advantage of the disclosed organomineral pigment-fillers is their high coloring efficiency. To achieve the same color intensity lower concentrations of the organic dyes and are used.

### EXAMPLES

The following examples are presented to further illustrate the present invention but are not to be construed as limiting the scope of the invention thereto.

### Example 1

Micronized clinoptilolite with mean particle size 20 microns is mixed in aqueous solution of cationic fuchsine dye Basic Red 9, at 1% of the weight of zeolite. After drying, a high intensity colored organomineral pigment-filler is obtained. The obtained organomineral pigment-filler is applied to polyamide (PA) “Nylon 6” at 10% of the weight of polyamide. The samples colored with organomineral pigment-filler exhibit remarkably higher color intensity compared to the samples colored with the same concentration of neat dye. The comparison in color intensity of polyamide samples colored with 10% organomineral pigment-filler and colored with the equivalent quantity of neat dye is illustrated in FIG. 1.

### Example 2

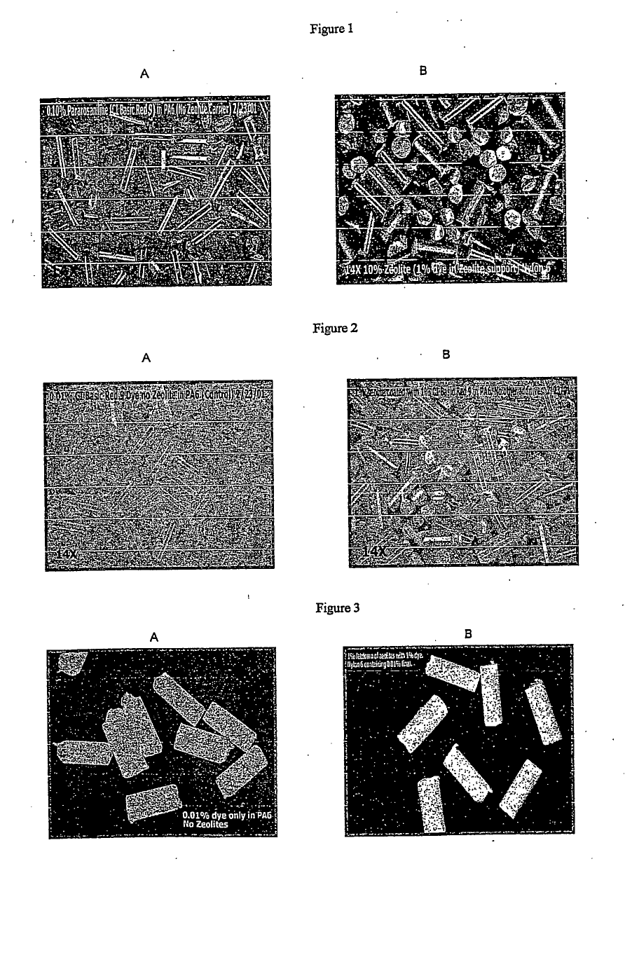

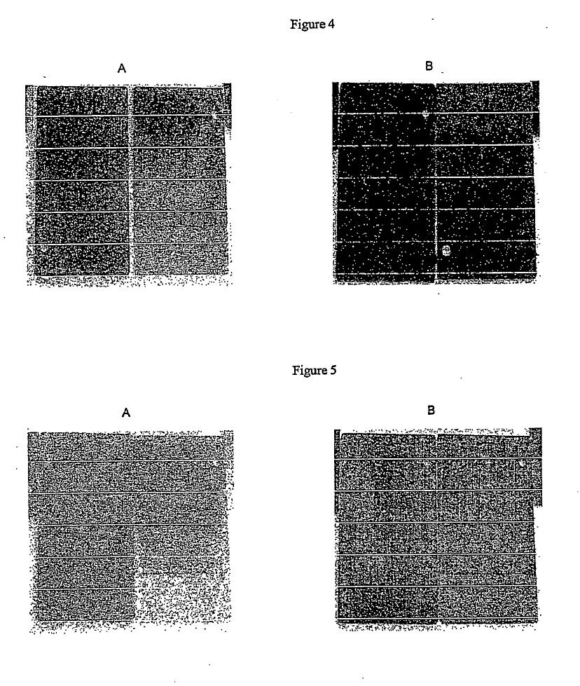

Organomineral pigment-fillers are produced as in Example 1. The obtained organomineral pigment filler is applied to polyamide 6 at 1% of the weight of polyamide. The organomineral pigment is very well dispersed and can effectively color the polyamide material. Polyamide 6 colored with an equivalent quantity of fuchsine, without having been fixed on the zeolite surface, is not colored at all, as shown in FIG. 2. The fluorescence under black light of the samples colored with the organomineral pigment filler and with neat Basic Red 9 is compared. The fluorescence under black light is brighter and whiter when zeolites are used as a support of the dye as shown in FIG. 3.

### Example 3

Micronized clinoptilolite with mean particle size 20 microns is mixed in alcohol-water (ratio 1/10) solution of cationic dyes Magenta 8122 and Fuchsia 8356 (Robert Koch Industries Inc.), at 2% of the weight of zeolite. After drying, high intensity colored materials are obtained. The obtained organomineral pigments are applied to high-density polyethylene at 1% of the weight of polyethylene. The organomineral pigment is very well dispersed and can effectively color the polyethylene material. Polyethylene colored with an equivalent quantity of dye, without having been fixed on the zeolite surface has very low color intensity as shown in FIGS. 4 and 5.

### Example 4

Synthetic hydrotalcite layered Mg—Al hydroxycarbonate [Mg₄ Al₂ (OH)₁₂ CO₃.4H₂O)] is treated with acid textile dye “Sandolan Brilliant Red 249” (Clariant Corp. dye) in neutral aqueous solution at 4% of the weight of hydrotalcite. The obtained organomineral pigment has very good color and does not fade out during subsequent washing, which confirms that the dye is completely fixed on the surface of hydrotalcite particles. FIG. 6 illustrates the polyamide samples colored with Sandolan Brilliant Red 249 supported on hydrotalcite.

### Example 5

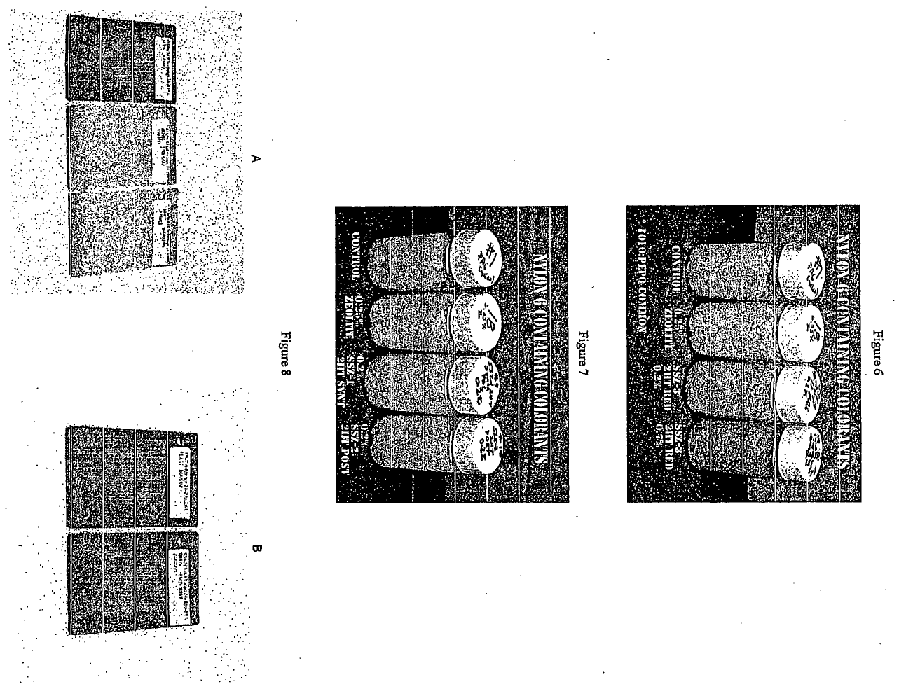

Synthetic hydrotalcite layered Mg—Al hydroxycarbonate [Mg₄ Al₂ (OH)₁₂ CO₃.4H₂O)] is colored during the end stage of its synthesis by addition of 4% acid textile dye “Sandolan Yellow E-2GL” (Clariant Corp. dye) into the aqueous solution. The hydrotalcite obtained has high intensity yellow color. FIG. 7 illustrates the polyamide samples colored with Sandolan Yellow E-2GL dye supported on hydrotalcite.

### Example 6

The synthetic Zn—Mg—Fe hydrotalcite [Mg₄ Zn₂ Fe₂ CO₃ (OH)₁₆.4H₂O] is colored as in Example 4. The hydrotalcite particles of the synthetic Zn—Mg—Fe hydrotalcite have yellow-brownish color. However, when colored in brown or black, this hydrotalcite material exhibits superior coloring properties at a significantly lower cost in comparison to the pure synthetic Mg—Al hydrotalcites.

### Example 7

Organomineral pigment-fillers are produced as in example 1. The dye used is Basic Red 46. The increased thermostability of the organomineral pigment-filler obtained according to the present invention compared to the neat dye is illustrated by the Heat Stability Testing GC MS of both Neat Basic Red 46 dye and the organomineral pigment filler obtained by fixing of Basic Red 46 on zeolite. The heat stability tests are performed at 200° C., 230° C. for 15 and 30 minute residence times.

The investigated samples are placed into glass vials and heated for 15 and 30 minutes in a circulating air oven at 200 and 230° C., removed and cooled to room temperature followed by putting volatile components into a chloroform solvent for GC MS analysis.

The results show that the organomineral filler obtained by fixing the Basic Red 46 at 2% on zeolites particles surface is more heat stable than the neat dye alone. The heat residence at 200 C for both 15 and 30 min residence times of the organomineral pigment-filler obtained according to this invention is excellent. The neat dye starts immediately breaking down at 200 C.

### Example 8

Experimental samples of organomineral pigment-fillers are produced as in Example 3. The experimental samples are tested under conditions of artificial weathering in QUV 340 Accelerated Weathering Tester. Polymers colored only by mixing with neat dyes are used as a comparison. The samples colored with organomineral pigment-fillers exhibit higher resistance to weathering compared to the polymeric samples colored only with neat dye chromogens in the absence of UV stabilizers. The samples colored with neat dye chromogens are completely discolored in 400 hours in QUV 340. There is no discoloration of the samples colored with organomineral pigment fillers at these conditions (See FIG. 8).

### Example 9

### Injection Molded Articles after QUV Aging

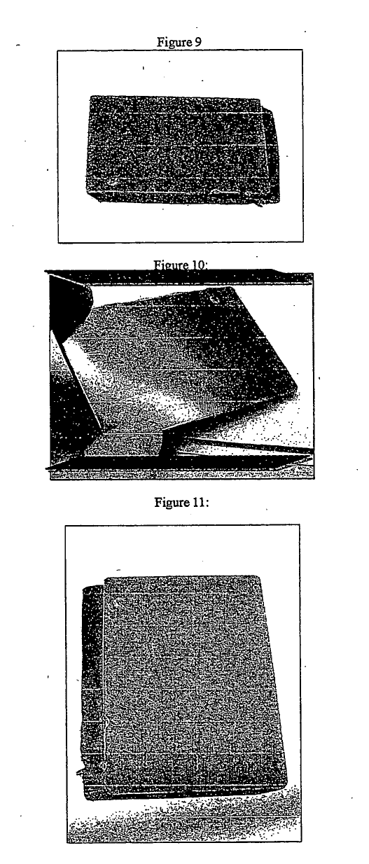

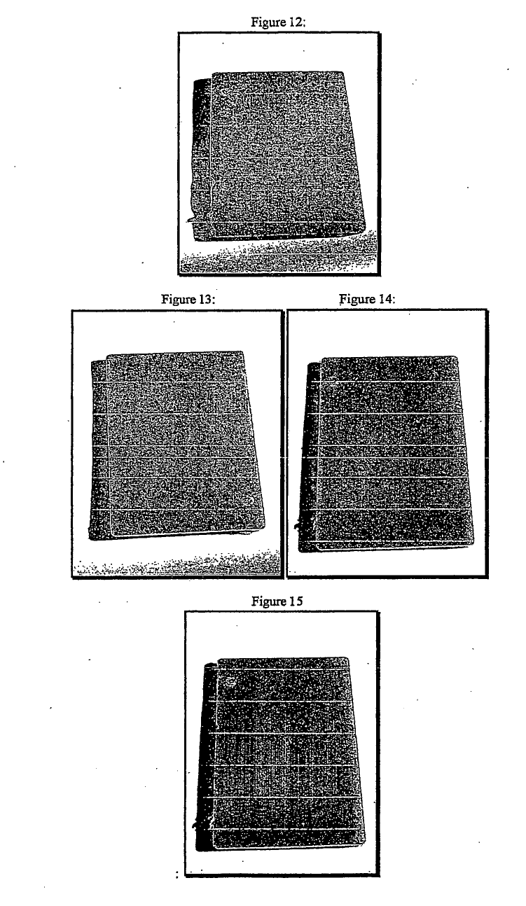

Reference is made to FIG. 9, a photograph of a HDPE injection molded plaque colored with copper phthalocyanine Blue 15:1 after 1000 hrs QUV exposure. Referring to FIG. 10, which is a photograph of the same plaque taken after 800 hours QUV exposure, this shows surface crazing has begun after 800 hours. FIG. 11 is a photograph of an HDPE molded plaque containing 0.10% copper phthalocyanine blue pigment exposed for 1,100 hours QUV340. Fading is evident on the surface of plaque. The darker top and bottom of the plaque is where the sample was mounted and unexposed. Surface Crazing is observed. Referring to FIG. 12 which is a photograph of an HDPE injection molded plaque colored with copper phthalocyanine blue at 15:1, after exposure to 1,100 hours QUV340 there is evident surface crazing over entire surface of plaque. Surface crazing started at 800 hours exposure.

FIG. 13 illustrates a photograph of an HDPE injection molded plaque colored with 1 wt. % Zeodex Blue according to the invention including a UV absorber after 1,100 hours of QUV340 Exposure. There is no surface crazing with very slight fading.

In FIG. 14, the HDPE injection molded plaque contains 1% Zeodex Blue pigment according to the invention and a combination of UV absorber and HALS after 1,100 hours QUV340 exposure. There is no fading or surface crazing.

FIG. 15 is a photograph of an HDPE injection molded plaque containing 1% Zeodex Blue pigment and a combination of UV absorber and HALS after 1,100 hours of QUV340 Exposure. There was no surface crazing or fading of pigment.

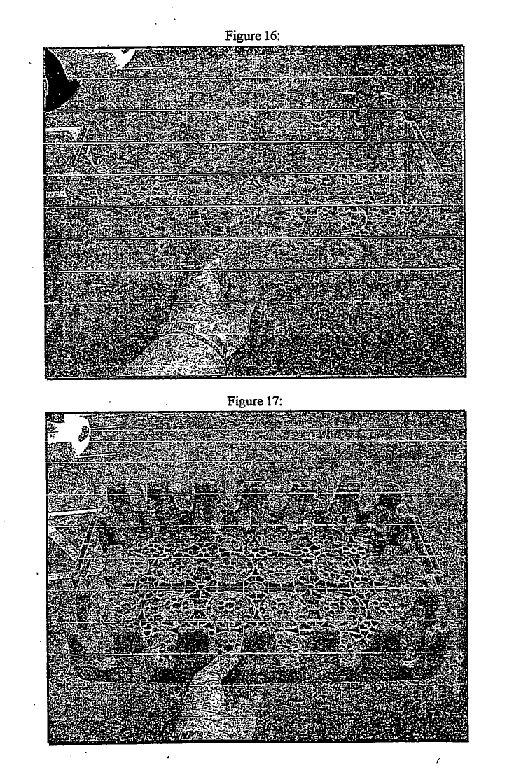

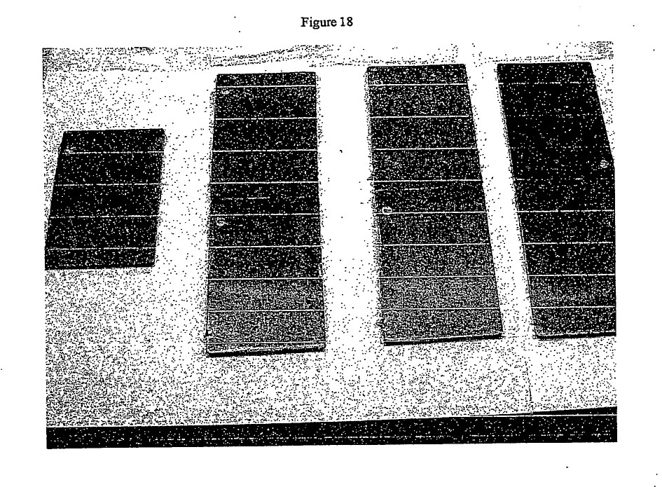

FIG. 16 is a photograph of an HDPE injection molded beverage crate according to the invention containing 1% Zeodex Red pigment. No warpage is observed and excellent dimensional stability is achieved, essential for stable crate stacking.

FIG. 17 is a photograph of an HDPE injection molded beverage crate containing 1% Zeodex Blue. No warpage was observed and great dimensional stability is achieved for crate stacking.

### Example 10

HDPE parts are injection molded and colored with organomineral pigment filler prepared according to example 1 with the Basic dye “Blue X-GRL Basic Blue 41”. For comparison the same parts are injection molded and colored with 0.1% pthalocyanine blue. The parts containing organomineral pigment filler do not warp and have higher dimensional stability compared to the parts colored with pthalocyanine blue which warp badly.

The above parts of Example 10 molded in the form of pallets, weighing 18 kg exhibited no warping under high throughput production conditions.

### Example 11

Natural zeolite clinoptilolite, with mean particle size 40 microns, is homogenized in water solution of cationic dye Maxilon Rot at different ratio to the weight of zeolite. Due to the ion exchange process, an insoluble zeolite-colorant complex is achieved, which can be used as an organomineral pigment-filler. The obtained organomineral pigment-filler is activated at 140 C up to 180 C and is pelletized in low density polyethylene (LDPE). The mechanical properties of the specimens produced by injection molding are determined by means of the generally accepted testing methods and their color is estimated visually. The test results are shown in Table 1.

TABLE 1
Composition and tensile properties of LDPE containing organomineral
pigment filler

| | | | | | Tensile | |
|---|---|---|---|---|---|---|
| Polymer | | | OMPF | Color of the | Strength, | |
| Type | Content, % | Dye Type | Content, % | composition | N/mm² | Elongation % |
| LDPE | 100 | — | 0 | White | 9.33 | 163 |
| LDPE | 95 | 0.5% red dye | 5 | ruby red | 9.11 | 149 |
| LDPE | 90 | 0.2% red dye | 10 | Red | 9.25 | 142 |
| LDPE | 80 | 0.2% red dye | 20 | dark red | 9.18 | 124 |
| LDPE | 90 | 0.05% red dye | 10 | gray red | 9.31 | 140 |
| LDPE | 80 | 0.05% red dye | 20 | gray red | 9.10 | 115 |

The compositions are intensely colored according to the color of the organomineral pigment-filler even in thin films. The tensile strength of the composite based on low-density polyethylene differs slightly from the tensile strength of the initial polymeric material.

### Example 12

Natural zeolite clinoptilolite, with mean particle size 40 microns, is homogenized in water solution of cationic dye Fuchsia 8356 at 1% to the weight of zeolite. The obtained organomineral pigment-filler is activated at 140 C up to 180 C and is pelletized in high-density polyethylene (HDPE). The mechanical properties of the specimens produced by injection molding are determined by means of the generally accepted testing methods and their color is estimated visually. The test results are shown in Table 2 and Table 3.

TABLE 2
Composition and tensile properties of HDPE containing organomineral
pigment filler

| | | Organomin. | | Tensile | | Tensile | Tensile |
|---|---|---|---|---|---|---|---|
| Polymer | | pigment filler | Color of the | Strength, | | modulus, | Modules |
| Type | Content, % | content, % | composition | MPa | Elongation, % | MPa | Increase, % |
| HDPE | 100 | 0 | white | 17.7 | 95.18 | 414.2 | |
| HDPE | 98 | 2 | red | 17.9 | 97.03 | 425.9 | +2.8 |
| HDPE | 95 | 5 | red | 18 | 59.74 | 442 | +6.7 |
| HDPE | 90 | 10 | dark red | 18.1 | 22.61 | 628 | +51.6 |
| HDPE | 80 | 20 | dark red | 19.2 | 10.52 | 877 | +111.7 |

The color intensity of the composite depends on the organomineral pigment filler content. The tensile and flexural strength of injection-molded composite based on high-density polyethylene is higher compared to the tensile strength of the initial polymer material. By addition of 10% and 20% organomineral pigment filler the tensile moduli of the HDPE composite increased 51.6% and 112%, and the flexural moduli of the HDPE composite increased with 20 and 53% as shown in TABLE 2 and TABLE 3.

TABLE 3
Composition and flexural properties of HDPE containing organomineral
pigment filler

| | | Organomineral | | | | Flexural | Flexural |
|---|---|---|---|---|---|---|---|
| Polymer | | pigment filler | Color of the | Flexural | Flex Str | modulus, | Modules |
| Type | Content, % | content, % | composition | Strength, MPa | increase % | MPa | increase % |
| HDPE | 100 | 0 | white | 21.81 | | 573 | |
| HDPE | 98 | 2 | red | 21.98 | +0.8 | 591 | +3.2 |
| HDPE | 95 | 5 | Red | 22.64 | +3.8 | 630 | +9.95 |
| HDPE | 90 | 10 | dark red | 22.82 | +4.6 | 684 | +19.4 |
| HDPE | 80 | 20 | dark red | 26 | +19.2 | 877 | +53.1 |

### Example 13

Natural zeolite clinoptilolite, with mean particle size 40 microns is homogenized in water solution of cationic dye Basic Red 9 at 0.50% to the weight of zeolite. The obtained organomineral pigment-filler is pelletized in polyamide (PA) Nylon 6. The mechanical properties of the specimens produced by injection molding are determined by means of the generally accepted testing methods and their color is estimated visually. The test results are shown in Table 4.

TABLE 4
Composition and properties of polyamide PA containing organomineral
pigment filler

| | | Organomineral | | Tensile | | Tensile |
|---|---|---|---|---|---|---|
| Polymer | | pigment filler | Color of the | Strength, | | modulus, |
| Type | Content, % | content, % | Composition | MPa | Elongation, % | MPa |
| PA 6 | 100 | 0 | White | 56 | 52.3 | 2401 |
| PA 6 | 90 | 10 | Red | 55 | 9.6 | 2912 |
| PA 6 | 80 | 20 | Red | 55 | 4.0 | 3121 |
| PA 6 | 70 | 30 | dark red | 55 | 3.5 | 3914 |

The color intensity of the composite depends on the organomineral pigment filler content. The tensile strength of the composite differs slightly from the tensile strength of the initial polyamide material. The tensile modules of the PA composite almost doubles by increasing the concentration of organomineral pigment up to 30%.

### Example 14

Determination of recrystallization Temperature for Blue OMPF in HDPE Compound formulation: The HDPE and the pigment are mixed in a Henschel mixer. Specimens with dimensions 75×50×3 mm were prepared by injection molding at melt temperature 180-220° C.

TABLE 14

| | | First Heating | | |
|---|---|---|---|---|
| | | Onset | Endset | Peak |
| Example | Wt. % Pigment | (° C.) | (° C.) | (° C.) |
| 14-A¹ | 1% | 121.39 | 132.94 | 128.57 |
| 14-B² | 0.02% | 120.80 | 132.98 | 128.57 |
| Control | 0.00 | 117.81 | 133.65 | 128.12 |
| Compar.* | 15:1 | 124.61 | 136.48 | 131.23 |
| | | First Cooling | | |
| | | Onset | Endset | Peak |
| Example | Wt. % OMPF | (° C.) | (° C.) | (° C.) |
| 14-A¹ | 1% | 118.89 | 112.6 | 117.29 |
| 14-B² | 0.02% | 118.34 | 110.94 | 116.71 |
| Control | 0.00 | 118.37 | 112.47 | 117.21 |
| Compar.* | 15:1 | 123.53 | 115.75 | 121.72 |
| | | Second Heating | | |
| | | Onset | Endset | Peak |
| Example | Wt. % OMPF | (° C.) | (° C.) | (° C.) |
| 14-A¹ | 1% | 117.35 | 132.61 | 128.77 |
| 14-B² | 0.02% | 120.63 | 132.13 | 128.12 |
| Control | 0.00 | 120.55 | 131.72 | 127.96 |
| Compar.* | 15:1 | 125.07 | 136.23 | 132.3 |
| | | Second Cooling | | |
| | | Onset | Endset | Peak |
| Example | Wt. % OMPF | (° C.) | (° C.) | (° C.) |
| 14-A¹ | 1% | 119.09 | 111.84 | 117.51 |
| 14-B² | 0.02% | 118.28 | 111.57 | 116.73 |
| Control | 0.00 | 118.48 | 112.99 | 117.23 |
| Compar.* | 15:1 | 123.45 | 114.99 | 121.50 |

*Copper phthalocyanine blue 15:1
14-A¹ 1% Blue OMPF loading in HDPE; Blue OMPF contains 2% Basic Blue 41 dye fixed on micronized zeolite
14-B² 0.02% Basic Blue 41(neat) in HDPE
Control HDPE T50-2000 Bamberger Polymers (Density 0.953 g/cc; MFI of 20 g/10 min)

Table 14 illustrates the effect of copper phthalocyanine blue on polyolefin HDPE crystallization temperature compared to OMPF, and neat dye. Example 14-A represents a 1% loading of OMPF. 14-A samples contain 0.02% dye in bound form. OMPF pigment provides bright coloration, and no tendency to shift the recrystallization temperature of the resin. Example 14-B provides unacceptably little or no coloration. In accordance with the invention, injection molded parts with effective low levels of bound colorant do not contribute appreciable warping by their presence alone, in thick section, as well as thin section-injection molded articles.

### Example 15

Micronized clinoptilolite with particle size 20 micron is mixed in water solution of the cationic dye Basic Violet 2 (Abbey Color Co.) at 2% of the weight of zeolite. The obtained organomineral pigment-filler in paste form is added and homogenized in latex paint in combination with conventional components. The color of the latex paint depends on the color of the organomineral pigment-filler used and its intensity depends on the pigment-filler concentration. The organomineral pigment-filler increases the coloring potential and hiding power of the latex paint. Two or more organomineral pigment-fillers with different colors can be added to achieve the desired color effect.

OMPF polypropylene resin injection molded articles herein contain polypropylene hompopolymer, copolymer or a combination of homo- and copolymer polypropylene, whereby each resin has a melt flow as measured by ASTM D1238 in units of g/10 minutes in a range selected from 2 to 35, and preferably from 5 to 20. These resins are commercially available widely. All of the various polypropylene homopolymers and copolymers are known and generally discussed in Volume 16 of Kirk-Othmer's Encyclopedia of Chemical Technology, 3rd Edition, pp 453-467 and in Volume 13 of Encyclopedia of Polymer Science and Engineering, 1988, pp 464-530. The polydispersity index of polypropylene Q (Mw/Mz) can not be lower than 2 and not higher than 12. Injection molding of polypropylene of a polydispersity less than 2 into parts with surface area to volume ratio of 2 and results in low throughput rates, inadequate melt flow and/or excessive pressure and incidence of warping. Broad Mw distributions greater than 5 have increased warpage tendency due to high Mz molecular weight fractions. OMPF compounds herein provide increased production rates with comparatively less molded-in stress. In the practice of the invention, there are other factors which are considered detrimental to part quality and should be avoided, such as imprecise temperature control, improper part design, sharp variations in wall thickness, flow path too long in the mold, parts ejected too hot, inadequate or poor location of ejection mechanism, and insufficient control of the temperatures between the core and the cavity sides of the mold.

OMPF polyolefin compounds of the present invention can be prepared by mixing the OMPF and required stabilizer system and optional additives to be used as desired, by means of a V-blender, a ribbon blender, Henschel mixer, a tumble blender or the like and kneading the mixture by means of a kneading machine such as Banbury mixer, a kneader, an oven roll, a single screw extruder, a twin-screw extruder or a single reciprocating screw at a temperature higher than the melting temperature of the resin preferably at a temperature of the melting temperature of the polyolefin. As is conventional, pellets, or pills of the polyolefin compound are formed for subsequent injection molding. The preferred practice of the invention provides a OMPF masterbatch. A representative OMPF masterbatch (MB) in accordance with the invention is prepared by combining the following components:
46 wt % LLDPE (MFI 85)
20 wt % LLDPE powder (MFI 30), as MB resin,
4 wt % Zn stearate,
15 wt % OMPF with 2 wt % Basic Blue 3 fixed by ion exchange reaction on the surface of clinoptilolite zeolite having a mean particle size of 40 microns, and
15 wt % OMPF Blue 41 which is a 2 wt % Basic Blue 41 dye fixed by ion exchange reaction on the surface of clinoptilolite with mean particle size 40 microns.

Pellets or pills of MB are produced in a single screw compounding extruder operating at 80 rpm with an extruder temperature Profile in each zone of: 120, 125, 130, 135, and 150° C. Color OMPF masterbatch according to the invention is preferably let down into a polyolefin at 2 to 4 wt %.

A preferred OMPF color masterbatch contains 25 to 50wt % of an OMPF that contains from 1 to 8 wt. % of ionic dye affixed to surfaces of micronized zeolite (10-80 μm avg., preferably 30-50 μm avg.). The OMPF is melt compounded in a masterbatch carrier resin selected which may be polyethylene or polypropylene, but is preferably LLDPE (MFI 20-100) In a particular embodiment a mixture of carrier masterbatch resin and 25 wt % of an OMPF based on micronized clinoptilolite containing 2 wt % ionically bound dye on the surface is let down into the final polyolefin injection molding compound at 4%. The final polyolefin compound is injection molded and contains 1% of the OMPF. The amount of active bound dye present in the molded article is 0.02%. A preferred masterbatch can optionally further comprise a processing additive and 1-30% of stabilizer system required for the final molding compound. A second masterbatch containing 70-99% of the required stabilizer system is let down into the polyolefin resin. In an exemplary stabilized MB, OMPF is 25 wt %, about 2 wt % of a 1:1 mixture of a primary and secondary antioxidant blended into the masterbatch (range of blended antioxidant from 1-5%), UV absorber is added at 5% (typically in a range of 3-10%), and a HALS is added at 5% (typical range of 3-10%).

A preferred OMPF masterbatch comprises 25 to 50 wt % OMPF, from 1 to 3% of total usage level each of a UV absorber and HALS, and the MB let down with a second masterbatch containing 97-99% each of the final required usage level of UVA and HALS into the final polyolefin compound, prior to the step of injection molding.

A preferred OMPF masterbatch containing 25 wt % of zeolite containing 8% bound dye is incorporated into a polyolefin molding compound at 4% letdown level provided in the final polyolefin injection molding an amount of 0.08% of bound cationic dye. For example in an HDPE injection molded compound, incorporating from 25 to 50 wt % of an OMPF as micronized zeolite particles surface bound to from 1 to 8 wt % cationic dye, a letdown range of from 2 to 4 wt % provides an effective amount of bound dye as low as from 0.005 wt % to 0.16 wt %.

The organic substances with ionic chromogens that can be fixed by ion exchange on the surface of the inorganic ionic materials include basic and acid dyes. The basic dyes suitable for affixing on the surface of crystalline zeolite materials are selected from methine-, polymethine-, cyanine-, azo-, anthraquinone-, triphenylmethane-, azine-, thiazine-, phthalein dyes. Of these basic dyestuffs, C. 1. Basic Red 12, 13, 27, 37, C. 1. Basic Orange 21, 22, 27 and C. 1. Basic Yellow 11, 21, 28, 29, 51 of methine-series, C. 1. Basic Red 13 and C. 1. Basic Yellow 13 of cyanine-series, C. 1. Basic Yellow 34, 36 and C. 1. Basic Red 18, 34, 38, 39 of azo-series, C. 1. Basic Violet 25 and C. I. Basic Blue 21, 22, 60 of anthraquinone-series, C. 1. Basic Blue 3 (CAS 55840-82-9) C. I. Basic Violet 1, 3, 14 and C. I. Basic Red 9 of triphenylmethane-series, and C. I. Basic Blue 3, 9, 24, 25 of thiazine-series are preferable. The most preferred basic dyes exhibiting blue color in replacement of or use in combination with copper phthalocyanine blue is listed under Chem. Abstracts Service no, 12270-13-2, also referred to as C.I Basic Blue 41 is Benzothiazolium, 2-[[4-[ethyl(2-hydroxyethyl)amino]phenyl]azo]-6-methoxy-3-methyl sulfate (salt) and and C.I. Basic Blue 3 (CAS 55840-82-9).

The preferred OMPF materials are commercially available from Zeodex International and based on Clinoptilolite fraction with particles of average diameter less than 40 microns.
Zeodex™ ZJJ Blue 2-300-2, 2% Cationic Blue X-GRL—Basic Blue 3
Zeodex™ ZJJ Blue 41-250-2, 2% Cationic Turq. Blue X-GB—Basic Blue 41
Zeodex™ ZM Yellow 29-200-5, 5% Basic Yellow 29 200%
Zeodex™ ZM Yellow 28-250-2, 2% Basic Yellow 28 250% X-2RL
Zeodex™ ZM Yellow 13-250-2, 2% Basic Yellow 13 250% X-8GL
Zeodex™ ZJJ Yellow 19-200-2, 2% Cationic Yellow 2-RL 200%—Basic Yellow 19
Zeodex™ ZJJ Red 46-250-2, 2% Cationic Red X-GRL 250%—Basic Red 46
Zeodex™ ZM Green MAP-100-2, 2% Malachite Green Powder B-4 100%

A representative stabilizer system employed in polyolefin injection molding compounds according to the present invention contains for high density polyethylene:
1. Hindered Amine Light Stabilizer at 0.05-0.5 wt %; such as Hostavin® N30,
2. Ultraviolet Absorber, at 0.05-0.5 wt %; such as CyasorbS UV531 or chemical equivalent.
3. Primary and Secondary Antioxidant at 0.05-0.15 wt %., such as Irganox®) 1010 and Irgafos 168.

A stabilizer system employed in polyolefin injection molding compounds according to the present invention contain for polypropylene:
1. Hindered Amine light stabilizer in wt % range from 0.05-0.50%: e.g., Hostavin® N30
2. Ultraviolet Absorber in wt % range from 0.05-0.50%.: e,g, Cyasorb® UV531

Essential stabilizer additives added to the injection molding polyolefin compounds according to the invention are primary and secondary antioxidants, such as sterically hindered phenols, secondary aromatic amines or thioethers, as described in “Kunststoff-Additive” Gachter/Muller, Ed. 3, 1990 p. 42-50, the contents of which are incorporated herein by reference; acid scavengers such as sodium, magnesium or calcium stearates or lactates, hydrotalcite or alkoxylated amines; U.V. absorbers;, and sterically hindered amines (for example N-unsubstituted, N-alkyl or N-acyl substituted 2,2,6,6-tetra-methylpiperidine compounds) [also known as hindered amine light stabilizers —HALS]. The U.V. absorbers include (e.g. 2-(2′-hydroxyphenyl)-benztriazoles, 2-hydroxy-benzophenones, 1,3-bis-(2′-hydroxybenzyl) benzene salicylates, cinnamates and oxalic acid diamides;). Other optional components include U.V. quenchers such as benzoates and substituted benzoates, antistatic agents, flameproofing agents, lubricants, plasticizers, nucleating agents, metal deactivators, biocides, impact modifiers, fungicides, and inorganic fillers.

Inorganic filler, either reinforcing or non-reinforcing type may be optionally further included in injection molding compounds according to the invention. Examples of inorganic fillers (reinforcing or non-reinforcing) include carbon black, calcium carbonate, magnesium carbonate, kaolin, calcined clay, talc, aluminum silicate, calcium silicate, silicic acid, carbon fiber, glass fiber, asbestos fiber, silica fiber, zirconia fiber, aramid fiber, potassium titanate fiber, etc. The amount of the filler is not specifically limited, but is of a design choice. Generally, the filler could be present in an amount of about 1-200 parts by weight relative to 100 parts by weight of the thermoplastic resin depending largely on the physical properties needed. A more typical amount of reinforcing filler for polyolefins polypropylene or HDPE is from 1 to 50 wt. %. Reinforcement improves modulus, and tensile strength, but at the sacrifice of toughness. If high performance toughness properties must be maintained, relatively less filler can be tolerated, as typically, the toughness of the molded material is reduced in direct proportion to the amount of fillers added.

A suitable primary antioxidant can be selected from among the many phenolic antioxidants, in particular, Irganox® 1010, Irganox® 3314, or Goodrite® 3114. In such a case from 0.01 to 0.2% (especially about 0.1%) of phenolic antioxidant based on the weight of polymer is present. Secondary antioxidant which is suitable is Irgafos® 168, Mark® 2112 or Sandostab PEPQ, at a loading of 0.05-0.15% each at 1:1 or 1:2 AO: Phosphite or Phosphonite. Other coadditives preferably employed include metallic stearates at 0.05-0.15% preferably at 0.10% wt.; with metal component selected from Zinc, Calcium, Magnesium, Sodium, Cesium, Cerium, Lithium, and Aluminum. Alternative lubricants beside metal stearate include waxes, montan, ester waxes, Acrawax® C, etc.

A further additive that is added to polypropylene calcium stearate. This is preferably added in an amount of 0.01 to 0.2% especially 0.1% based on the weight of polymer in the polymeric material.

The polyolefin compound for injection molding employs suitable UV absorber having a broad absorption from 290-420 nm and an absorptivity (liters/gm-cm) above 35 l/gm-cm at both lambda maximas. Preferred UV absorbers are selected to be compatible in the polyolefin matrix and synergistic with a hindered amine light stabilizers containing a secondary amine of low passivity, similar to tertiary amines i.e., having a pKa value of from 5 to 7.

Suitable UV absorber include benzophenones, benzotriazoles, oxalanilides (e.g., 2-ethy12′-ethoxy-oxalanilide, Sanduvor® VSU. The benzotriazoles include Tinuvin® 234, 2-(2H-benzotriazol-2-yl)-4,6-bis(1-methyl-1-phenylethyl)phenol. The benzophenones include 2-hydroxybenzophenones, such as Cyasorb® UV 9, 24, 207, 284, 416, 531, and 2126; Uvinul® 3000, 3008, 3040, 3049, 3050, and 3060; hydroxy substituted benzotrizoles include Cyasorb® 5411 and Tinuvin® 234, 326, 327, 328, 384, 900, and 1130; triazines such as Cyasorb® 1164 and 1164(L), Tinuvin® 1577, and Uvinul® T-150; salicylic add ester; formamidine; cyanoacrylates such as Uvinul® 3038 and 3039; and benzyldene malonate esters such as Cyasorb® 1988; and 2-hydroxyphenyl-s-triazines and hindered amine light absorbers (HALS) such as Tinuvin® 770, Tinuvin® 944 or Tinuvin® 946.

Aging testing on injection molding compounds herein and known in the art include Xenon Arc WoM G26, SAE J1885, SAE J1960, QUV340 and QUV 313. The UV studies of injection molding compounds in accordance with the invention in HDPE, show that OMPF based on zeolite bound with Blue 41 is improved over zeolite bound with Blue 3 as OMPF-Blue 41 provides surprising better UV stability in combination with UV absorber and HALS. This is thought to be due to absence of protonation of the HALS nor absence of interference with the UV absorber providing excellent environmental aging in polyolefins, and no warping. OMPF containing Blue 41 bound by cationic exchange to surfaces of Zeolite exhibits a ph of 8 to 8.8 and results in polyolefin peroxide dissociation significantly less than 6%. Whereas copper phthalocyanine blue exhibits a pH of 6.1 and 46% dissociation of hydroperoxide in 2 hrs, 55% dissociation in 4 hrs and in 23 hours, 74% of hydroperoxide is dissociated.

In a preferred embodiment OMPF compounds based on (HDPE) comprises HDPE and a combination of the following stabilizers Hostavin® N30, and Cyasorb® UV531 in a range of wt.-wt. ratio of 4:1 to 1:4, especially 3:1, 2:1, 1:1, 1:2, and 1:3, respectively. The most preferred OMPF compounds comprise one or more HALS compounds, a UV absorber, a primary and a secondary antioxidant, and antacid (i.e., acid acceptors).

A preferred embodiment of the invention is a composition comprising a piperidine compound and a second HALS compound in the range of ratios (wt./wt.) of 3:1 to 1:3, especially 2:1, 1:1, and 1:2. The second HALS is exemplified by commercially available products such as
Tinuvin® 123 bis-(1-octyloxy-2,2,6,6,tetra-methyl-4-piperidinyl)sebacate
Tinuvin®622, Cyasorb®) 3346, Cyasorb® 3529, HA88 Sigma, BASF® 5050,
Chimassorb® 119, Chimassorb® 944—poly[[.beta.-[1,1,3,3-tetramethyl butyl)amino]-s-triazine-2,4-diyl][[2,2,6,6-tetramethyl-4-piperidyl)imino]hexamethylene [(2,2,6,6,-tetramethyl-4-piperidyl)imino]].

Other Factors in Injection Molding Processing of Compounds

Compounds according to the invention do not contribute in themselves, increased tendency toward shrinkage in thick section and thin section injection moldings. However, it is understood that shrinkage and warpage may be inherent in the injection molding process based upon factors other than coloration pigments. Residual stresses induced during molding that overcome the structural integrity of the part will result in warping upon ejection from the mold or cracking from external service loads. Understood mechanisms giving rise to these phenomena include differential changes in density of the polymer during cooling from the processing temperature to ambient temperature. Warpage analysis may be undertaken using computer models available in the art that analyze tolerances as part of part design. Actual computations can factor in more than thirty variables such as type, size, geometry and location of gate(s); wall thickness and its distribution in the product; molecular orientation; geometry of gated section of part; variability of material, mold temperature, machine, molding and inspection environment; distance of the critical dimension from the gate, and the geometry of the part section at the important dimension. Such analysis results provide a model of the attainable, long term part tolerances, relevant cycle and holding times, required material and machine control, cavity dimensions corrected for shrinkage, and maximum tolerances of the metal mold cavity dimensions.

Beverage cartons, especially for packaged beverages like carbonated and non carbonated beverages made according to the invention in high output injection moldings preferably utilize HDPE of higher density, and lower MFI, for example:
Dow Chemical HDPE 08064N, MFI of 8, density of 0.964;
Dow HDPE 10062N, MFI of 10, density 0.962;
Quantum Petrothen® 380B1, 8 MFI, density 0.958;
Solvay & Cie, Eltex® B2008 MFI of from 0.9 to 3.8, density of 0.956; and
Bamberger Polymers, Bapolene® 2162, MFI of 10 and density of 0.962.

Compounds suitable for molding thin-walled parts preferably utilize high flow, HDPE of density 0.95-0.96, and MFI of above 15 to as high as 70, for example Dow HDPE 42060N having a 42 MFI and density of 0.960.

Injection molded pallets formed according to the present invention contain generally a top platform of stringers linked by runners below; or as many unitary moldings provide, there are a plurality of legs arrayed beneath the deck portion with integrated beam structures, spaced apart to form passageways between legs and beams for passage of forks from fork lifts or pallet jacks, used conventionally in transporting goods loaded on pallets. The pallet may be a single unitary structure, or a modular structure as is known in the art. Pallet components may be molded in several pieces, and the pieces fused together, or fastened at assembly by screws, rivets, bolts, or snap-lock configurations, and the like. The polyolefin pallet molding may form a hollow cavity, or recess which receives one or more associated structural metal members. Metal members may be incorporated by insert injection molding techniques which are known in the art. In insert injection moldings, metal members are placed inside the mold cavity, and embedded in the injection melt.

Pallets according to the invention are particularly suited for holding loads. Other configurations of pallets suitable for holding items on casters are illustrated in U.S. Pat. Nos. 5,117,762, 5,791,261, and 6,446,563, and 5,787,817, the disclosures of which are expressly incorporated herein by reference in their entirety. Any type of pallet formed from shot sizes, for example, of 10 kgs. and higher is achieved with excellent productivity. Color fastness, and long term environmental aging stability without concern for the specific designed shape, in light of the above considerations for conventional mold design especially with regard to providing good melt flow paths, low tortuosity and flow balancing through appropriate sprues and runners.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An injection molded article substantially absent warping, from a shot size of 1 kg and higher, and in a shape having a surface area to volume ratio of 2 and higher, comprising a polyolefin injection molding compound, said compound comprising a polyolefin resin, an organomineral pigment filler (ompf), a uv absorber, hindered amine light stabilizer, and antioxidant, wherein said organomineral pigment filler comprises cationic or anionic inorganic micronized particles, said particles containing a defined range of 0.01 to 15 wt % of ionic bound dye, such amount not exceeding the surface ionic exchange capacity of the crystalline, micronized mineral.

2. The article of claim 1 wherein said injection molding compound is a mixture of a OMPF masterbatch let down into said polyolefin resin, said OMPF masterbatch comprises 25 to 50 wt % said OMPF, a MB resin, from 1 to 30% of total usage level in said molding compound, each of a UV absorber and HALS, and said masterbatch is let down with a second masterbatch containing 70-99% each of the final required usage level of UV absorber and HALS into said molding compound, prior to injection molding.

3. The injection molded article of claim 2 wherein said OMPF masterbatch contains 25 to 50 wt % of said OMPF as micronized zeolite particles surface bound to from 1 to 8 wt % cationic dye, and incorporated into said polyolefin molding compound at 2 to 4 wt % letdown level, said injection molded article containing an amount of from 0.005 wt % to 0.16 wt % of said cationic dye.

4. The injection molded article of claim 1 in the shape of a pallet.

5. The injection molded article of claim 1 in the shape of a beverage container.

6. The injection molded article of claim 1 wherein said resin is HDPE, said HALS is present at from 0.05-0.5 wt % and said UV absorber is present at from 0.05 to 0.5% wt, and further comprises from 0.05 to 0.15% of a primary antioxidant and from 0.05 to 0.15% of a secondary antioxidant.

7. A polyolefin injection molding compound comprising a polyolefin selected from (a) polypropylene having a melt flow index (MFI) as measured by ASTM D1238 in units of g/10 minutes in a range selected from 2 to 35 and a polydispersity index Q (Mw/Mz) of from 2 to 12, and
(b) HDPE having an MFI of from 15 to 70 and a density of 0.95-0.96, a UV absorber, a hindered amine light stabilizer, an antioxidant, and an organomineral pigment filler comprising crystalline cationic or anionic micronized particles, said particles containing an amount of from 1 to 8 wt % of a dye ionically bound to the surface of said micronized particles, said amount not exceeding the surface ion exchange capacity of said particles.

8. The polyolefin compound of claim 7 wherein said dye comprises a combination of C.I Basic Blue 41-Benzothiazolium, 2-[[4-[ethyl(2-hydroxyethyl) amino]phenyl]azo]-6-methoxy-3-methyl sulfate (salt) and C.I. Basic Blue 3 (CAS 55840-82-9).

9. An organomineral pigment filler comprising crystalline micronized mineral particles of a cationic or anionic charge, and ionically bound organic dye of the corresponding counterionic charge, wherein said dye is not present in excess of the surface ionic exchange capacity of said particles.

10. The article of claim 1 wherein said particles contain a defined range of 1.0 to 8 wt. % of said ionic bound dye on weight of OMPF.
